(19) United States
(12) Patent Application Publication
(10) Pub. No.: US 2025/0101794 A1
(43) Pub. Date: Mar. 27, 2025

(54) CONCEALMENT CABINET

(71) Applicant: Mt Tremper Holdings, LLC, White Plains, NY (US)

(72) Inventor: Robert Blum, White Plains, NY (US)

(73) Assignee: Mt Tremper Holdings, LLC, White Plains, NY (US)

(21) Appl. No.: 18/897,520

(22) Filed: Sep. 26, 2024

Related U.S. Application Data
(60) Provisional application No. 63/585,352, filed on Sep. 26, 2023.

(51) Int. Cl. E05G 1/02; A47B 51/00; A47B 81/00

(52) U.S. Cl. CPC E05G 1/02; A47B 51/00; A47B 81/00

(57) ABSTRACT

A concealed furniture article includes a front storage section and a rear hidden storage compartment that is located behind the front storage section. The concealed furniture also includes a safe for storing articles and a lift mechanism that is fixedly connected to the safe and to a rear wall of the concealed furniture article. The lift mechanism is operable to move the safe between a raised position and a lowered position in which the safe is fully concealed within the rear hidden storage compartment.

### CROSS-REFERENCE TO RELATED APPLICATION

The present application claims priority to and the benefit of U.S. patent application Ser. No. 63/585,352, filed Sep. 26, 2023, which is hereby expressly incorporated by reference in its entirety.

### TECHNICAL FIELD

The present disclosure is directed to furniture and more particularly, to a concealment cabinet in which an article is configured to move between a lowered position in which the article is hidden from view and a raised position in which the article is raised and in view and is accessible by a user. In one particular application, the article is one or more safes each of which is configured to hold a plurality of articles. For example, the safe can be a watch safe.

### BACKGROUND

Concealment furniture is a piece of specialty furniture that includes a hidden storage compartment. Hidden storage compartments can be used to hold different types of articles/objects and can have many different constructions, such as most often a hidden drawer. One of the more common types of concealment furniture is hidden gun storage and gun concealment furniture that are configured to store a firearm(s) in a hidden storage compartment to safely store the firearm but allow quick access in the event of an emergency.

### SUMMARY

In one embodiment, a concealed furniture article includes a front storage section and a rear hidden storage compartment that is located behind the front storage section. The concealed furniture also includes a safe for storing articles and a lift mechanism that is fixedly connected to the safe and to a rear wall of the concealed furniture article. The lift mechanism is operable to move the safe between a raised position and a lowered position in which the safe is fully concealed within the rear hidden storage compartment.

In another embodiment, a concealed cabinet includes a front storage section and a rear hidden storage compartment located behind the front storage section. The cabinet includes a safe and a lift mechanism that is fixedly connected to the safe and to a rear wall of the concealed furniture article and is operable to move the safe between a raised position and a lowered position in which the safe is fully concealed within the rear hidden storage compartment. The lift mechanism has: 1) a motorized mount to which a rear of the safe is attached; and 2) a guide mechanism for supporting a front mass of the safe, thereby taking stress off the lift mechanism at a rear of the safe. The guide mechanism includes a pair of slides, each slide including a first slide part fixedly attached to one respective side of the safe and a second slide part coupled to one side wall of the rear hidden storage compartment. The second slide part has an extendable length to accommodate raising of the safe to the raised position.

### BRIEF DESCRIPTION OF THE DRAWING FIGURES

FIG. 1 is a front and side perspective view of a piece of concealment furniture in accordance with one embodiment and showing a closed position;

FIG. 2 is front and side perspective view of the concealment furniture showing an open position;

FIG. 3 is a side perspective view of the concealment furniture showing the open position;

FIG. 4 is a rear perspective view of the concealment furniture showing the open position;

FIG. 5 is a front perspective view of the concealment furniture showing the open position;

FIG. 6 is a cross-sectional view of the concealment furniture;

FIG. 7 is another cross-sectional view of the concealment furniture;

FIG. 8 is a perspective view of one exemplary lift mechanism that forms a part of the concealment furniture;

FIG. 9 is a perspective view of a section of the concealment furniture showing the lift mechanism and main controller mounted to a rear wall thereof;

FIG. 10 is a perspective view of a fixed lid bracket that can form a part of the lift mechanism; and

FIGS. 11A and 11B show an optional lock mechanism and a modular connector system;

FIG. 12 is a top plan view of an outer enclosure in the form of a frame for placement around the safe; and

FIG. 13 is a front elevation view of the outer enclosure.

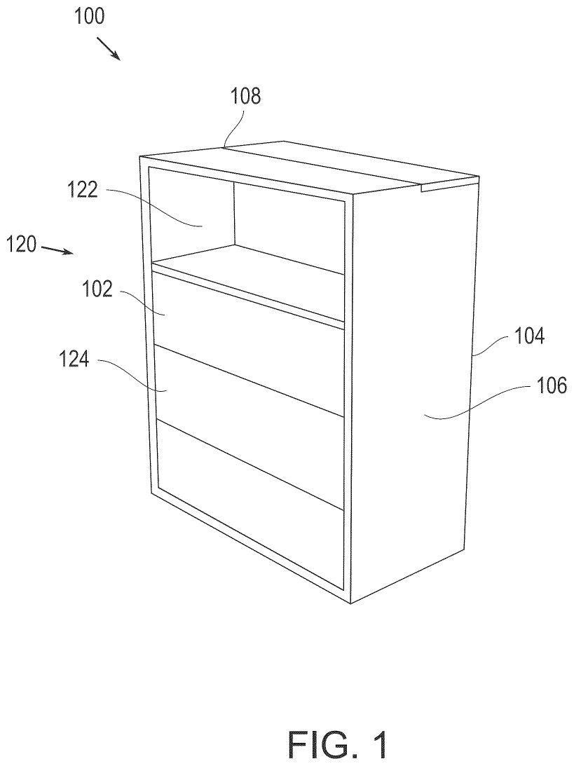

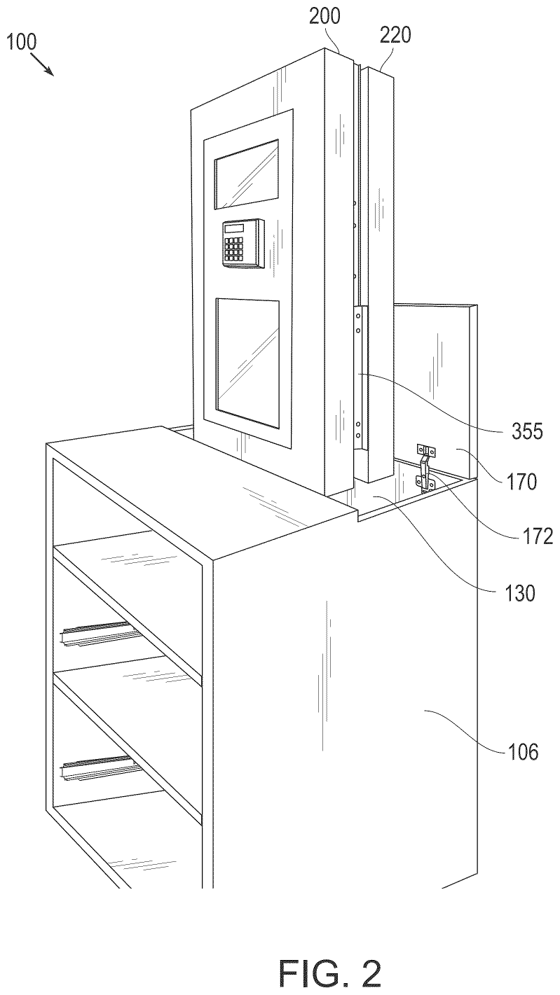

### DETAILED DESCRIPTION OF CERTAIN EMBODIMENTS

With reference to the attached figures and illustrations, a concealment cabinet 100 is illustrated and is configured to include traditional visible storage in the front and a hidden storage compartment in the rear.

The concealment cabinet 100 includes a front face 102, an opposite rear face 104, a first side 106, and opposite second side 108, a top surface or face 110 and an opposite bottom surface of face 112. As mentioned, the cabinet 100 includes a visible storage space 120 that is located and accessible along the front face 102 and a hidden storage space 130 that is located in the rear of the cabinet 100 and is accessible along at least one face of the cabinet 100. In the illustrated embodiment, as described in more detail herein, the hidden storage compartment is accessible along the top surface 110. In particular, the top surface has a movable section that when opened reveals the hidden storage compartment.

It will be understood that the size and shape of the illustrated concealment cabinet 100 is not limiting and it can take many different shapes and sizes within the spirit of the present disclosure.

### Visible Storage 120

The illustrated visible storage space 120 comprises one or more open cubbies 122 and one or more drawers 124. For example, the open cubby 122 can be located above the drawers 124 with a bottom wall of the cubby 122 separating the cubby 122 from the drawers 124. The drawer 124 can take a traditional form in that it includes a drawer front, a drawer bottom, a drawer box, and a drawer glide or slide mechanism that allows the drawer 124 to be easily opened and closed. The slide mechanism is typically formed of drawer tracks and drawer runners. Ball bearing drawer slides are one or the most common type of drawer slides. They can be made with steel ball bearings that roll in a thin track.

It will also be appreciated that instead of drawers, one or more cabinet doors can be used. In other words, any number of types of storage arrangements can be used, including open cubby space, sliding drawers, cabinet doors, etc. In sum, the visible storage 120 is located along the front of the cabinet 100 and has a traditional appearance and functionality and can take many different forms.

### Concealed Storage 130

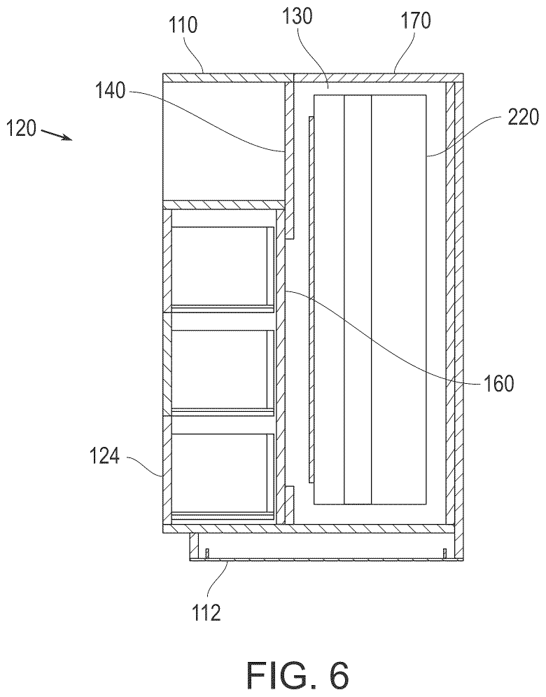

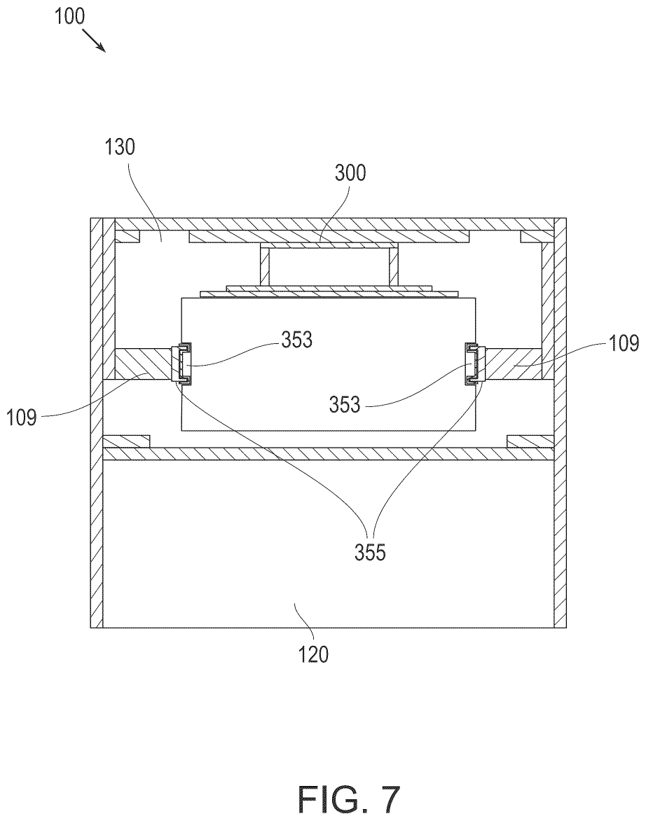

As described herein, the cabinet 100 includes the hidden storage space 130 (concealed storage space). The visible storage space 120 is preferably separated from the concealed storage space 130 by an internal (vertical) rear wall 140. Thus, the rear of the open cubby 122 is defined by this internal rear wall 140 and when the drawers 124 are removed, the internal rear wall 140 or a section thereof can be visible. The internal rear wall 140 can include a removable false back infill panel 160. As shown, the removable false back infill panel 160 can occupy a bottom portion of the internal rear wall 140. Removal of this panel 160 permits direct access into the hidden storage space 130. The removable false back infill panel 160 can be coupled to the surrounding internal rear panel 160 by using fasteners, such as screws, etc. This internal rear wall 140 thus hides the special functionality of the cabinet 100 and in particular, the presence of the concealed storage. In FIG. 6, the panel 160 is shown in a different embodiment and is not coplanar with the rear wall 140. Instead, the panel 160 covers the through opening formed in the rear wall 140 that provides access to the hidden storage space 130.

The top surface 110 of the cabinet 100 can have a split construction since the rear section of the top surface 110 provides selective access to the hidden storage space 130. For example, the top surface 110 can be defined by a flip up door 170 that is mounted to the frame of the cabinet with hidden hinges 172. The door 170 moves between an open position in which the door 170 assumes a vertical position (at least approximately perpendicular to the top surface 110) and a closed position in which the door 170 is in a horizontal position and is coplanar with a top wall of the visible storage space 120. When the door 170 is in the open position, the hidden storage space 130 at the rear of the cabinet is accessible and in view. In other words, a person can look down into the hidden storage space 130 when the door 170 is in the open position.

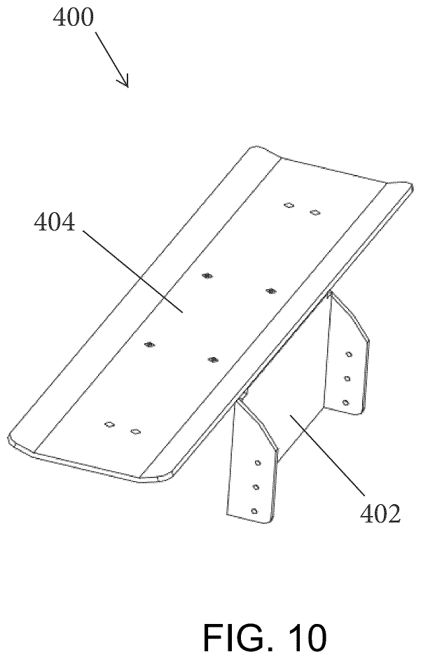

It will also be appreciated that instead of a hinged door, other arrangements can be used. For example, instead of a hinged door, the door 170 can be directly coupled to the top of the safe and/or to the top of the lift mechanism (FIG. 10) so that when the safe is raised, the door 170 is raised in a horizontal state. In this alternative embodiment, the door 170 thus represents a fixed cap on top of the safe.

It will be appreciated that the door 170 can include a lock mechanism for locking the door 170. The lock mechanism can be a mechanical lock, such as a key lock, or can be an electronic lock that opens via an RFID car or app or other means of transmission, such a Bluetooth based system.

### Concealed Safe 200

In accordance with the present disclosure, the hidden storage space 130 contains a safe 200 that is configured to hold a plurality of articles, such as valuables. In one particular application, the safe 200 is designed to hold watches and thus can include watch related accessories such as watch holders, watch compartments, watch winders, etc. It will be appreciated that the safe can hold other valuables, such as jewelry, wine, cigars, etc. When raised, the safe 200 allows others to view the valuables in a safe, secure manner.

The safe 200 can take any number of different shapes and sizes with the more common shapes being rectilinear, such as the rectangular shaped safe 200 shown in the figures. The safe 200 is formed of traditional safe materials, such as metals, commonly steel alloys, and has considerable weight given the material selection and the intent to make it difficult to transport. Safe 200 can include fireproofing materials as well.

The safe 200 also has an openable door 210 that is most often located along the front face of the safe 200 as shown. The door 210 can include one or more windows to allow the contents of the safe 200 to be viewed in the raised position. Alternatively, the door 210 can be formed of a solid metal (e.g., steel). In the case of watches, this allows the watches to be prominently displayed when the safe 200 is raised with the safe door closed for added security. The safe 200 also includes a lock mechanism, which can be an electronic lock (with keypad) 211 or a key lock or both, to limit access to the safe.

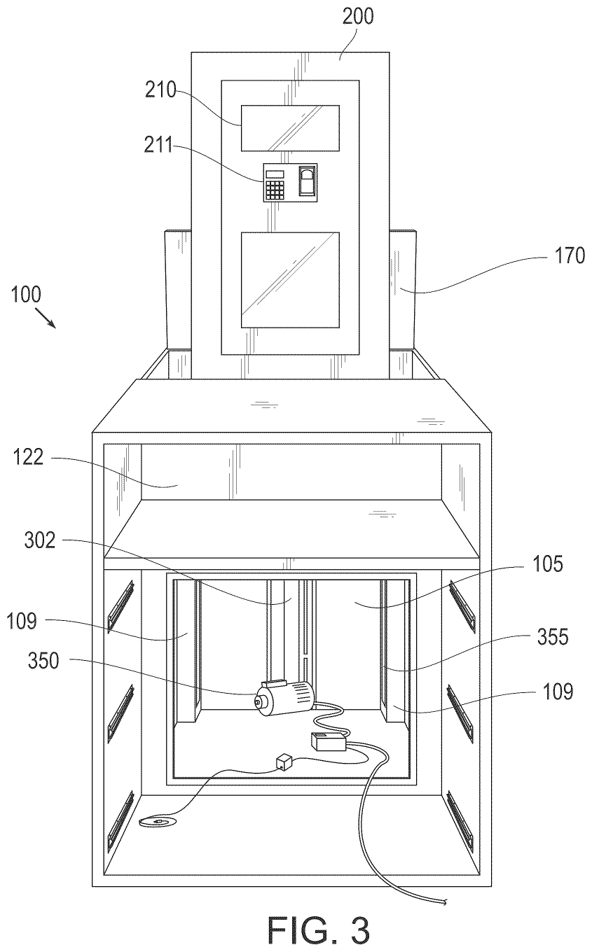

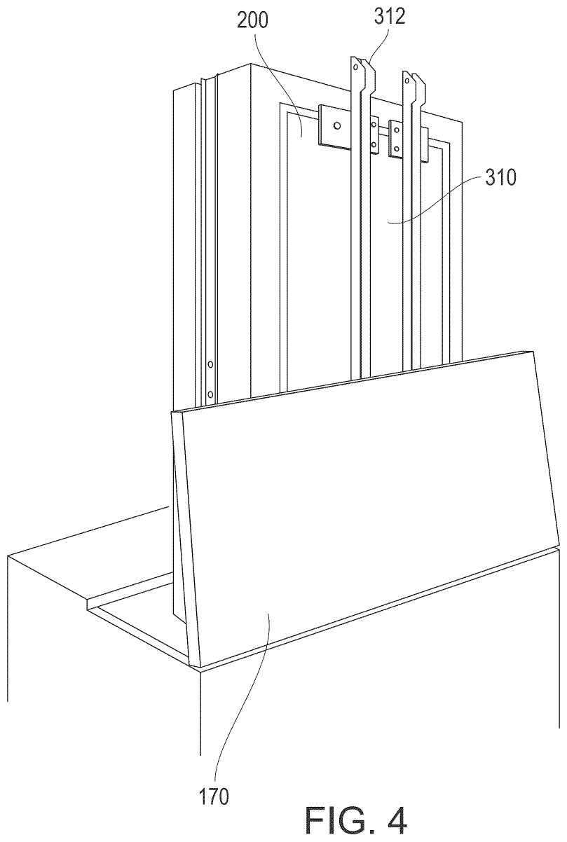

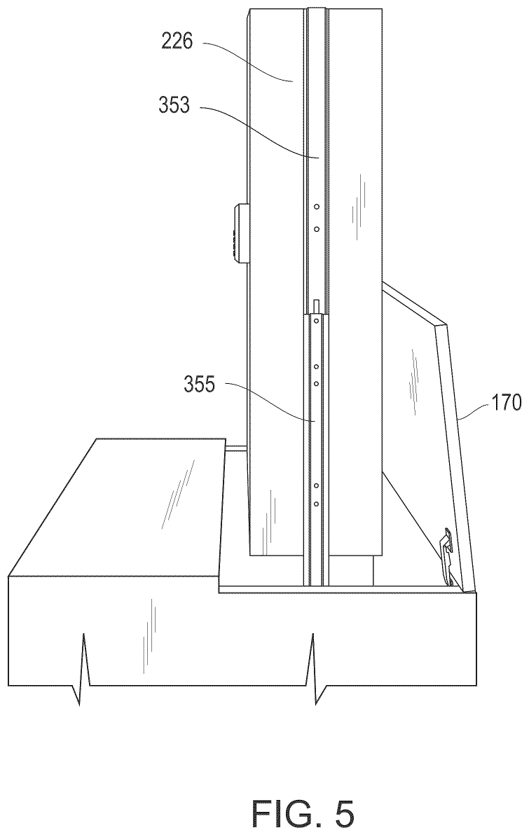

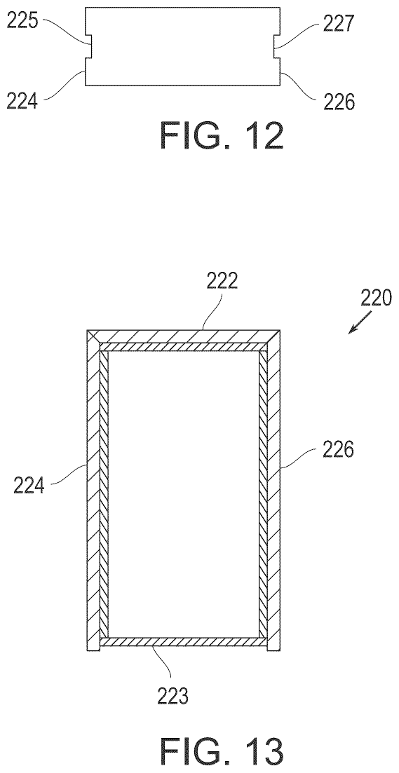

As shown in FIGS. 3, 12 and 13, the safe 200 is preferably contained within a safe frame 220 that surrounds the safe 200 and, as described herein, provides a usable frame for the lifting mechanism. The safe frame 220 has a hollow interior in which the safe 200 sits and includes a top wall 222, a bottom wall 223, a first side wall 224 and an opposing second side wall 226. The safe 200 can be coupled to the safe frame 220 using traditional techniques, such as fasteners. The safe frame 220 can be formed from wood or other material, such as metal. Along the first side wall 224, there is a first dado 225 that extends vertically and is open along the top and bottom edges of the first side wall 224. Similarly, along the second side wall 226, there is a second dado 227 that extends vertically and is open along the top and bottom edges of the second side wall 226. The safe frame 220 does not cover the front and rear faces of the safe 200. Alternatively, the safe frame 220 can be eliminated and the mounting hardware, guide tracks (slides), etc., can be directly attached to the sides of the safe 200.

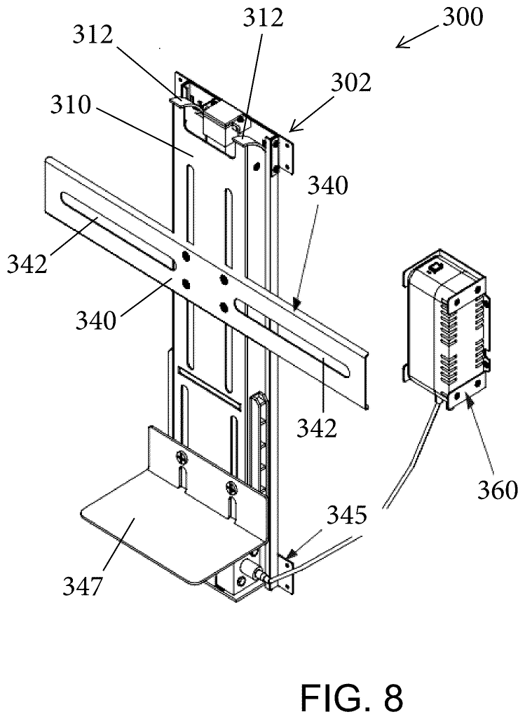

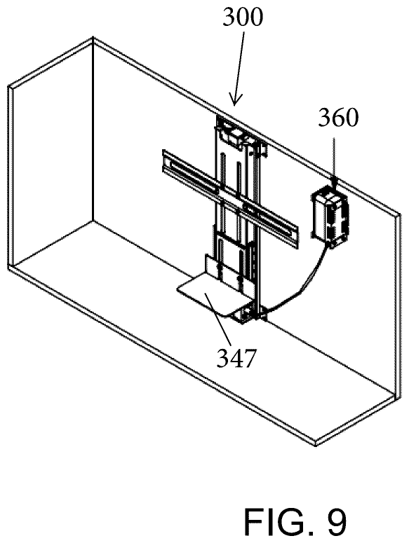

### Lift Mechanism 300 (FIGS. 8 and 9)

A lift mechanism 300 is provided to controllably raise the safe 200 from a lowered concealed position to a raised display position. Any number of suitable lift mechanisms 300 can be used so long as they are robust and capable of lifting the significant weight of the safe 200. The lift mechanism 300 thus must be configured to raise a mass that is much heavier than traditional products, like a TV. Thus, the illustrated lift mechanism 300 is only exemplary in nature and not limiting of the types of lifts mechanism that can be used. The lift mechanism 300 is an electronic lift mechanism powered by one or more motors 350 and can be controlled by a user with a manual controller or a remote control (including via an app on a smart device, such as a smartphone), or both to effectuate controlled lifting and revealing of the safe 200. As described herein, the lift mechanism 300 can be considered to be a form of a linear actuator assembly or mechanism.

The lift mechanism 300 includes a main bracket 302 that is attached to a rear wall 105 that defines the rear face 104 of the cabinet 100. The main bracket 302 is attached using fasteners or the like and is mounted vertically along the inner surface of the rear wall 105 so that it is contained within the hidden storage space 130. The main bracket 302 is typically mounted so that its bottom end rests on or is close to the bottom floor of the hidden storage space 130. The main bracket 302 defines tracks for linear movement of other components of the mechanism in an up and down manner as discussed below.

The lift mechanism 300 also includes a mounting plate 310 that is movably coupled to the fixed main bracket 302 and moves between a raised position and a lowered position. The mounting plate 310 is an elongated structure with a top end 312 and an opposing bottom end. The mounting plate 310 rides within tracks of the main bracket 302 and in the raised position, at least a portion of the mounting plate 310 is located above the main bracket 302. The top end 312 of the movable mounting plate 310 acts as cam surfaces and thus, can be curved ends as shown. These curved ends assist in the raising and lowering of the door 170. In particular, when the mounting plate 310 moves linearly along the fixed main bracket 302 in an up direction, the curved ends contact the underside of the hinged door 170 and urge the door 170 to pivot upwardly and open as the mounting plate 310 continues its upward movement.

The movable mounting plate 310 is also coupled to a mounting bracket 340 that is fixedly attached to the front face of the mounting plate 310 using fasteners such as screws. The mounting bracket 340 is an elongated structure with a pair of slots 342 formed therein, with one slot at each end with a solid center section therebetween. The mounting bracket 340 is mounted such that it is perpendicular to the longitudinal axis of the mounting plate 310. The ends of the mounting bracket 340 protrude laterally outward from the sides of the mounting plate 310. The mounting bracket 340 is thus fixed to the mounting plate 310. The combined mounting plate 310 and mounting bracket 340 thus has a T-shape.

It will also be appreciated that the fasteners that pass through the slots 342 can be in the form of lock fasteners that effectuate locking of the safe 200 to the mounting bracket 340.

The safe 200 is coupled to the mounting bracket 340 by inserting fasteners through the slots 242 into the rear of the safe 200, thereby attaching the safe 200 to the front of the mounting bracket 340.

The lift mechanism 300 further includes a bottom mounting shoe 345 that is attached to the front face of the mounting plate 310 below the mounting bracket 340. The bottom mounting shoe 345 has an L-shaped construction and thus defines a shelf 347 that is oriented perpendicular to the longitudinal axis of the mounting plate 310. The shelf 347 thus extends forward. The bottom mounting shoe 345 is the part on which the safe 200 rests and thus, in combination with the mounting bracket 340 and other features discussed below, the lift mechanism 300 can support the weight of the safe 200. Moreover, as discussed below, in order to handle the weight of the safe, additional hardware is provided for handling the weight of the safe.

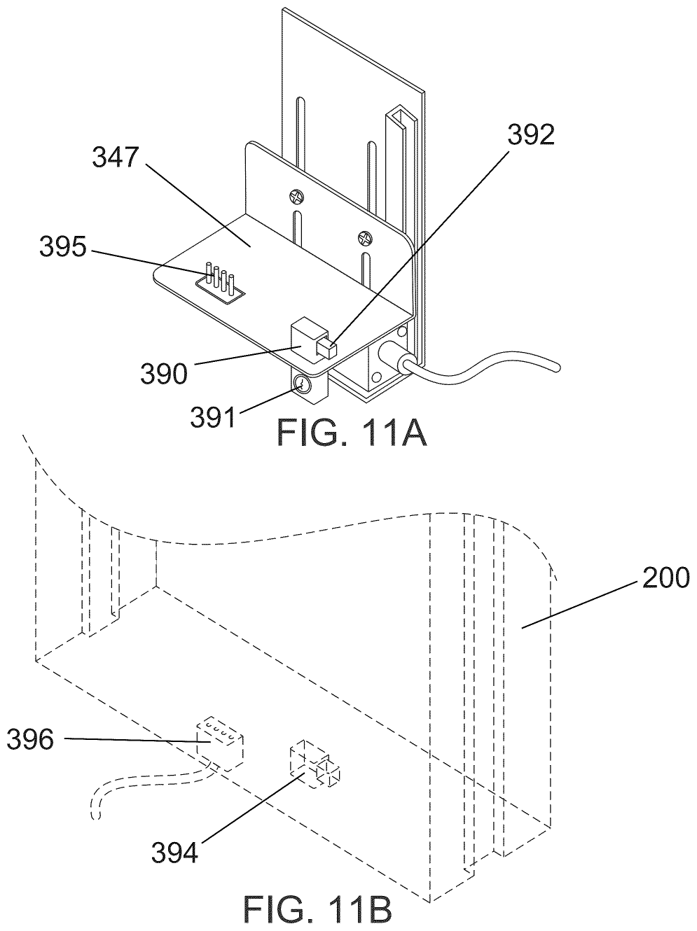

As shown in FIGS. 11A and 11B, in one embodiment, a lock mechanism can be provided and integrated into the shelf 347 for locking the safe 200 onto the shelf 347. Any number of mechanical lock mechanisms or electronic lock mechanism can be used as lock mechanism. For example, a simple lock mechanism that is accessible under the shelf can be provided and be a key based latch lock. This type of lock mechanism has a first lock component 390 that is associated with the shelf 347. The first lock component 390 can have a manual lock barrel/pin cylinder and a latch 392 and reacts to key movement. The bottom of the safe 200 thus has a complementary structure, such as a recessed area 394 and slot, that receives the latch lock or bolt 392 when the safe 200 rests on the shelf 347. To lock the safe 200 to the shelf 347, the user inserts and rotates the key to cause movement of the latch/bolt 392. Many other types of lock mechanisms can be used including manual and electronic ones.

In yet another embodiment shown also in FIGS. 11A and 11B, the shelf 347 can incorporate one or more modules 395 that are operatively (e.g., electrically) coupled to the control box 360. For example, one module 395 can be a light (LED) module that provides a connection to LEDs that are contained in the safe 200 itself. The bottom of the safe 200 has a complementary modular connector 396 that is connected to the LEDs in the safe 200. Thus, when the safe 200 is placed on the shelf 347, the module 395 connects to the connector 396 on the bottom of the safe 200 to establish a modular connection. This modular connection provides an easy way to connect the LEDs to a power source outside of the safe 200. In addition, a power connection can be made to the watch winders that are contained within the safe 200 in one embodiment. The power wires for the watch winders are routed within the safe 200 and then they are all routed to the modular connector at the bottom face of the safe 200. When module 395 connects to the modular connector, power is thus delivered to the watch winders. The modular connection can be a male/female type connection in that pins or prongs, etc., can be received within holes, etc. In this way, the safe is designed to provide a modular power connection to the lift mechanism. This avoids having to run separate power cables, etc. to each of the powered components in the safe.

In addition, a pair of sliding heavy duty ball bearing drawer slides are mounted within the hidden storage space 130 and in particular, are mounted to the side walls of the cabinet 100 and thus are mounted to the left and right of the safe 200. First parts 353 of the slides are mounted within the dados 225, 227 formed in the safe frame 220 (or alternatively, are attached directly to the sides of the safe 200) and second parts 355 of the slides are fixedly connected to the left and side walls of the cabinet 100. As will be appreciated the first parts 353 are configured to slidingly mate with the second parts 355 to establish a coupling and provide a guide to control movement of the safe as it is raised and lowered. The first parts 353 are fixedly attached to the sides of the safe 200, while the second parts 355 can be in the form of rails/tracks that are extendable (i.e., have extendable lengths) to accommodate the full movement of the safe 200. In particular, as shown, when the safe 200 is raised and exits the cabinet walls, the second parts 355 extend upward so that the first parts 353 remain engaged with the second parts 355 at locations outside of the cabinet. It will be appreciated that the lower sections of the second parts 355 can be fixed to the inner side walls of the cabinet and it is the upper sections that extend upward to increase the overall length of the second parts 355.

First and second parts 353, 355 can thus be considered to be a slide. In addition, the coupling of the hardware between the safe and the cabinet can have a dovetail configuration.

As shown, the two side walls of the cabinet can have projecting portions 109 (e.g., wood support beams) that extend into the hidden storage space 130 and extend vertically therein along the side walls to permit the second parts 355 to engage the smaller sized safe frame 220. The slides 353, 355 provide additional stability and support for the safe 200 as it moves between the raised position and the lowered position. More specifically, as a result of this support structure, when the safe 200 goes up and down, the front portion of its weight is supported in these slides 353, 355, taking the stress off the vertical lift mechanism 300 in the rear. Thus, unlike other lifts, like TV ones, the combination of the motorized lift mechanism with the slides 353, 355 provides a system for handling the increased weight of the safe 200. This feature provides the necessary structure to allow the lift mechanism to move the mass of the safe in a controlled manner.

One or more motors 350 are provided for controllably moving the mounting plate 310 and is operatively coupled thereto using gears or the like. The motor 350 is fixedly located within hidden storage space 130 and can be mounted to the bottom floor of the cabinet. The motor 350 is connected to a controller (control box) 360 as by wires and the controller 360 is mounted within the hidden storage space 130 (e.g., it can be mounted to the rear wall 105).

The motor 350 is operatively coupled to the mounting plate 310 so that operation of the motor 350 causes the raising and lowering of the mounting plate 310. The controller 360 can be used and a command, such as pressing a button, can be given to raise the safe 200. Upon receipt of the raise command, the motor 350 is actuated and is driven causing the mounting plate 310 to move upward along the guide tracks of the main bracket 302 until the raised position is reached. The motor can be a servo motor and therefore, the motor operates until the raised position is reached. Conversely, the controller 360 can be used and a command, such as pressing a button, can be given to lower the safe 200. Upon receipt of the lower command, the motor 350 is actuated and is driven causing the mounting plate 310 to move downward along the guide tracks of the main bracket 302 until the lowered, stored position is reached. The lowering of the safe 200 automatically results in the lowering and closing of the door 170.

The frame of the cabinet 100 and drawer components of the cabinet 100 can be formed of any number of different materials; however, they are typically formed of wood.

It will also be appreciated that the hidden storage space 130 can contain two safes 200 and two separate lift mechanisms 300 one for each safe 200. The two lift mechanisms 300 can be synchronized by the controller 360 so that they are raised and lowered together using a single raise command or lower command. In this embodiment, there is a center support structure within the hidden storage space that separates the two drive mechanisms 300 and provides a surface to which the two slides 353, 355 can be mounted, one associated with each safe 200.

In addition, as mentioned previously, instead of a hinged door, the door can be fixedly attached to the lift mechanism. In particular, as shown, a fixed door or lid bracket 400 (FIG. 10) can be attached to the top end of the movable mounting plate 310 and moves therewith. The fixed lid bracket 400 has a bottom section 402 that attaches to the mounting plate 310 and has a top section 404 that attaches to the door 170. In this way, the door (top lid) 170 is fixed to the vertically moving mounting plate 310 using traditional techniques, such as fasteners. When the lift mechanism 300 is operated and moves to the raised position, the door 170 is lifted up and travels with the mounting plate 310. Conversely, when the lift mechanism is lowered, the door 170 is lowered and seats flush against the frame of the cabinet in the at rest, lowered position.

Thus, the cabinet 100 can be a dual-purpose wood cabinet that provides conventional cabinet storage in the front, either with drawers or a door concealing shelves, and the back portion of the cabinet conceals the lift mechanism 300 that raises the (steel) safe 200, which can be a BlumSafe produced by the Applicant. A BlumSafe is a steel safe that is equipped with either an all-steel door or polycarbonate-windowed display door (at the buyer's option), to provide a level of security for an owner's jewelry, watches (on modular watch winders or in drawers), guns, papers and other valuables. The accommodation of the interior of the BlumSafe is user configurable.

As mentioned, the cabinet 100 and lift mechanism 300 of the cabinet 100 are specially engineered to hold the weight of the safe 200 and its internals. As part of the cabinet 100 implementation, the BlumSafe is contained in a wooden box frame 220 that has stabilizing vertical slides 353, 355 to assist with the bearing of the front-heavy weight of the safe 200 and prevent torquing of the lift arm at the back of the cabinet 100, as the back of the safe is attached to the lift mechanism 300.

The benefits for consumers of the cabinet 100 are multifold, derived from the applicant's experience manufacturing and marketing safes, watch-related accessories and other concealment devices to its customers. The Applicant's safes are engineered to be flush mounted in walls or cabinetry (though it offers an accessory to permit semi-flush mount as well). These safes are deeper than typical wall safes (approximately 7.25″ interior depth, vs 3.5″ of a typical wall safe) to permit the placement of watch winders and offer more flexible storage, while allowing the concealment opportunities provided by built-in wall safes.

Concealment is a major factor in protection of valuables, whether in a safe or not in a safe, particularly since almost all property theft in houses in the US are either from invitees or amateur burglars who are in and out of the home within ten minutes, rarely equipped with power or heavy tools, and are thieves of opportunity, taking valuables that are either out in the open or minimally secured or hidden.

While BlumSafe has experienced good demand for its safes since its commencement in 2017, a major deterrent to purchase for many consumers is that, while they need a deeper safe, they lack the wall depth for one. Yet they seek two or three elements that the BlumSafe provides: concealability, adequate storage volume for their valuables, particularly important for watch collectors seeking to have watch winders in their safe, and for many, the ability to see their watches and other valuables through a safe door with windows.

The cabinet 100 is the solution to this problem, by providing a standalone cabinet that conceals a BlumSafe until the owners issues the command to the unit to raise the safe. Unlike most TV lift cabinets, the utility storage space in the front of the unit additionally camouflages the purpose of the unit by making it seem like a piece of furniture with another purpose, whether placed in a bedroom, dressing room or living room. In addition to its storage and concealment utility, it has other features such as an electrical junction box, with two unswitched and one switched outlet, to power items in the safe like lighting and watch winders.

While an electric motorized lift mechanism is shown and described, the lift mechanism can be a pneumatic lift mechanism or other types of lift mechanisms.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

What is claimed is:

1. A concealed furniture article comprising:
a front storage section;
a rear hidden storage compartment located behind the front storage section;
a safe; and
a lift mechanism that is fixedly connected to the safe and to a rear wall of the concealed furniture article and is operable to move the safe between a raised position and a lowered position in which the safe is fully concealed within the rear hidden storage compartment.

2. The concealed furniture article of claim 1, wherein the concealed furniture article comprises a cabinet that has a top wall that includes an openable section that moves between a closed position in which the rear hidden storage compartment is concealed and closed off and an open position in which the rear hidden storage compartment is accessible and the safe can move to the raised position.

3. The concealed furniture article of claim 2, wherein the top wall includes a fixed section adjacent the openable section at a rear of the top wall, the openable section being pivotally attached to the rear wall and configured to automatically open when the safe moves to the raised position and applies a force to an underside of the openable section.

4. The concealed furniture article of claim 2, wherein the safe comprises a metal safe has a door that opens toward the front storage section and wherein in the raised position, the safe is positioned above the top wall.

5. The concealed furniture article of claim 1, wherein the lift mechanism has: 1) a motorized mount to which a rear of the safe is attached; and 2) a guide mechanism for supporting a front mass of the safe, thereby taking stress off the lift mechanism at a rear of the safe.

6. The concealed furniture article of claim 5, wherein the motorized mount includes a shelf on which the safe rests and a mounting bracket above the shelf to which the safe is fixedly attached.

7. The concealed furniture article of claim 6, wherein the motorized mount includes a vertical mounting plate to which both the shelf and the mounting bracket are attached, the vertical mounting plate moving between the raised position and the lowered position, the vertical mounting plate being operatively coupled to a motor.

8. The concealed furniture article of claim 1, wherein the lift mechanism includes a shelf on which the safe rests, the shelf including a lock mechanism for locking the safe to the shelf.

9. The concealed furniture article of claim 1, wherein the lift mechanism includes a shelf on which the safe rests, the shelf including a first modular connector that engages a second modular connector formed along a bottom surface of the safe to establish an electrical connection.

10. The concealed furniture article of claim 9, wherein the safe includes a plurality of watch winders and the electrical connection provides power to the plurality of watch winders.

11. The concealed furniture article of claim 9, wherein the safe includes internal lighting and the electrical connection provides power to the internal lighting.

12. The concealed furniture article of claim 5, wherein the guide mechanism comprises a pair of guide slides, each guide slide having a first part that is fixedly attached to one side of the safe and a second part coupled to a respective side wall of the rear hidden storage compartment.

13. The concealed furniture article of claim 12, wherein the second part has an extendable length.

14. The concealed furniture article of claim 12, wherein each respective side wall has a dado in which the first part is fixed and the second part of the guide slide is coupled to an inward protruding section of the respective side wall.

15. The concealed furniture article of claim 1, wherein the concealed furniture article comprises a cabinet that has a top wall that includes a fixed front section and an adjacent movable rear section that completes the top wall, the rear section of the top wall comprising a top cap of the lift mechanism.

16. The concealed furniture article of claim 1, wherein the lift mechanism comprises a pneumatic lift mechanism.

17. The concealed furniture article of claim 2, wherein the lift mechanism includes a fixed main bracket that is attached to the rear wall and a mounting plate that movably travels in an up-and-down direction along the fixed main bracket, wherein a top edge of the mounting plate has a curved end for contacting and opening the openable section.

18. A concealed cabinet comprising:
a front storage section;
a rear hidden storage compartment located behind the front storage section;
a safe; and
a lift mechanism that is fixedly connected to the safe and to a rear wall of the concealed furniture article and is operable to move the safe between a raised position and a lowered position in which the safe is fully concealed within the rear hidden storage compartment;
wherein the lift mechanism has: 1) a motorized mount to which a rear of the safe is attached; and 2) a guide mechanism for supporting a front mass of the safe, thereby taking stress off the lift mechanism at a rear of the safe, the guide mechanism includes a pair of slides, each slide including a first slide part fixedly attached to one respective side of the safe and a second slide part coupled to one side wall of the rear hidden storage compartment, the second slide part having an extendable length to accommodate raising of the safe to the raised position.

19. A concealed furniture article comprising:
a front storage section;
a rear hidden storage compartment located behind the front storage section;
a safe; and
a lift mechanism that is fixedly connected to the safe and to a rear wall of the concealed furniture article and is operable to move the safe between a raised position and a lowered position in which the safe is fully concealed within the rear hidden storage compartment;
wherein the lift mechanism includes a shelf on which the safe rests, the shelf including a first modular connector that engages a second modular connector formed along a bottom surface of the safe to establish an electrical connection.
